(19) United States
(12) Patent Application Publication
(10) Pub. No.: US 2003/0069829 A1
(43) Pub. Date: Apr. 10, 2003

(54) Public-venue auction system and method of operation

(75) Inventors: Laurie E. Gathman, East Norwich, NY (US); Jack E. Haken, Danbury, CT (US)

Correspondence Address: Corporate Patent Counsel, Philips Electronics North America Corporation, 580 White Plains Road, Tarrytown, NY, 10591, US

(73) Assignee: KONINKLIJKE PHILIPS ELECTRONICS N.V.

(21) Appl. No.: 09/971,128

(22) Filed: Oct. 4, 2001

(51) Int. Cl. G06F 17/60

(52) U.S. Cl. 705/37

(57) ABSTRACT

A public-venue auction system, and method of operation. In an electronic ticket control system associated with regulating etickets for events at a facility, an auction database is maintained for storing information related to auction items, and proposed terms of sale for them. Information relating to items for auction is received, processed, and transmitted by the electronic ticket control system. Patrons transmit bids through their virtual ticket device. A bid processor receives bids and, at a predetermined time, determines which of them is the highest. An auction event may be initiated by a buyer or seller, or by a third party. Once an auction event is consummated, the owner-operator of the facility will normally facilitate the exchange of consideration, and may provide an on-site clearinghouse for the purpose and charge an auction fee for facilitating the auction.

### CROSS-REFERENCE TO RELATED APPLICATIONS

The present invention is related to those disclosed in the following United States Patent Applications:

1. Serial No. [Docket No. US 010493], filed concurrently herewith, entitled “SELLING BEST AVAILABLE SEATS AT A PUBLIC FACILITY”;

2. Serial No. [Docket No. US 010494], filed concurrently herewith, entitled “SYSTEM FOR DISPLAYING PERSONAL MESSAGES AT A PUBLIC FACILITY AND METHOD OF DOING BUSINESS”;

3. Serial No. [Docket No. US 010495], filed concurrently herewith, entitled “SYSTEM AND BUSINESS FOR OFFERING SEAT UPGRADES TO PATRONS AT A PUBLIC FACILITY”;

4. Serial No. [Docket No. US 010496), filed concurrently herewith, entitled “BUSINESS METHOD AND SYSTEM FOR COMMUNICATING PUBLIC-FACILITY STATUS INFORMATION THROUGH A VIRTUAL TICKET DEVICE”;

5. Serial No. [Docket No. US 010497], filed concurrently herewith, entitled “TICKET EXCHANGE SYSTEM AND METHOD OF OPERATION”;

6. Serial No. [Docket No. US 010499], filed concurrently herewith, entitled “SYSTEM AND METHOD FOR SELL ING GOODS TO CUSTOMERS OF A PUBLIC FACILITY”; and

7. Serial No. [Docket No. US 010500], filed concurrently herewith, entitled “SYSTEM AND METHOD FOR SELLING IMAGE DISPLAY TIME TO CUSTOMERS OF A PUBLIC FACILITY”.

The above applications are commonly assigned to the assignee of the present invention. The disclosures of these related patent applications are hereby incorporated by reference for all purposes as if fully set forth herein.

### TECHNICAL FIELD OF THE INVENTION

The present invention is directed to electronic ticket control systems and, more specifically, to a system and method for operating an auction involving a plurality of public-facility patrons using virtual ticket devices.

### BACKGROUND OF THE INVENTION

Large public entertainment facilities, such as convention centers, concert halls, stadiums, sports arenas, and the like, are the civic centers of many communities and are important sources of revenue and employment. Quite often, public facilities are funded by taxpayers in order to attract or at least retain sports franchises, and to attract tourists and conventions. The large sums invested in public entertainment facilities make it essential to maximize the revenue derived from such facilities and to minimize their operating costs.

However, large public facilities tend to be labor intensive operations. A typical sports facility requires a large number of gate attendants, ticket agents, ushers, concession stand operators, shop vendors, and security officers, and the like. Many new sports facilities also employ waiters and waitresses who take orders from, and serve food and drink to, customers at their seats. Facility operators use labor-saving technology wherever possible in order to offset the high labor costs associated with large public facilities.

In addition to cutting costs, facility operators also try to increase revenue in a number of different ways. The principle sources of revenue are ticket sales, concession stands, and vendor shops. Promotions are frequently offered in order to increase sales and many public facilities do not permit patrons to bring their own food and drink into the venues. And facility operators are increasingly seeking new technology to provide new and useful services to customers and thereby increase attendance and revenue.

There is therefore a need in the art for technical improvements that reduce the costs of operating large public entertainment facilities. In particular, there is a need for new technologies that help to reduce labor costs associated with a operating large public facilities. At the same time, there is a need for technical improvements that enhance the revenues of large public facilities. More particularly, there is a need for new technologies that provide useful and enjoyable services to the patrons of large public facilities.

### SUMMARY OF THE INVENTION

To address the above-discussed deficiencies of the prior art, it is a primary object of the present invention to provide a virtual-ticket-device public-facility auction system and method. Note that a virtual ticket device is a portable computer system that receives and stores virtual tickets for sports events, theater, concerts, and the like. Various services and methods of doing business are linked to and implemented through the virtual ticket device.

In its simplest form, the virtual ticket device is an existing smart telephone or cellular communication-enabled personal digital assistant (PDA), such as a PALM PILOT™ or a VISOR™ electronic organizer. A dedicated virtual ticket device could also be used. A customer who wishes to attend an event purchases admission in any conventional manner (e.g., by telephone from a ticket service, in person at a box office, via the Internet). The ticket vendor sends an encrypted admission authorization record over a wireless channel or a wireline channel to the virtual ticket device, where it is stored as a virtual electronic ticket.

The encrypted admission authorization record may include, for example, information that identifies the date and location of the event, the seat number, price paid, and the like. The encrypted admission authorization record also may include uniquely encrypted information which may be used in a conventional manner to authenticate that the record is genuine. The same information is preferably stored in a central database is accessible by the event operator and/or his service provider. The record in the database should preferably also include the telephone number or wireless address of the virtual ticket device so that contact with the virtual ticket device may be established at a later time.

Entry-point terminals are provided at the entrances of the public entertainment facility which read at least the encrypted authentication information from the virtual ticket device and authorize the customer to enter the event. The entry-point terminals read the authentication information over a very short range wireless (RF) channel or infrared (IR) channel, or via a dedicated interface slot coupled to a wireline channel to prevent eavesdropping and spoofing of the process. For example, the virtual ticket device may be programmed to display the data either as a string of characters (e.g., serial number) or a bar code on its LCD display and the displayed information can be optically scanned in a chamber of the entry-point terminal.

In a preferred embodiment, the virtual ticket device includes memory to store electronic tickets and other information and a communications controller for establishing a communications link with a public facility terminal (that is, interface for communicating with a facility electronic ticket control system). Preferably both the virtual ticket device and the arena or theater is also equipped with hardware and software for tracking the location of the virtual ticket device in and around the entertainment facility with a precision of perhaps a few meters. Once the customer has purchased a virtual ticket, the virtual ticket device can be used, in conjunction with information stored in the database to provide a number of distinct information and marketing services to the customer.

It will be recognized that the virtual ticket device serves multiple functions to its user. There are clear synergies between many of these functions; for example the communications functions of the device may be enhanced when the customer's seat location and entry time are known and stored in the system. Nevertheless many aspects of the present invention remain new and useful even when the customer is admitted to the facility with a paper ticket or in another conventional manner and for this reason, the term “virtual ticket device” as used in this patent specification and the claims which follow, is not limited or restricted to a device which is actually used or even programmed to authorize a customer's admission to the facility.

In a preferred embodiment, the virtual ticket device includes an interface module for interfacing with a facility auction system receiving auction-related information from a virtual ticket device. In this embodiment, the invention further includes a facility database for storing item, bid, and confirmation information. A timing device for limiting the duration of an auction event is set to either a default period or accepts a time limit from a facility patron. A clearinghouse is preferably provided so that the public facility patrons have a location, which may include a payment confirmation system, at which to consummate sales based on accepted terms of exchange.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. In particular, a controller may comprise a data processor and an associated memory that stores instructions that may be executed by the data processor. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 is a plan diagram of an entertainment venue in which an electronic ticket control system according to the principles of the present invention may be deployed;

FIG. 2 illustrates a virtual ticket device which is capable of interacting with an electronic ticket control system according to the principles of the present invention;

FIG. 3 illustrates a virtual electronic ticket displayed on the virtual ticket device in FIG. 2 according to one embodiment of the present invention;

FIG. 4 illustrates an electronic ticket control system according to one embodiment of the present invention;

FIG. 5 is a flow diagram illustrating the operation of the electronic ticket control system and the virtual ticket device according to one embodiment of the present invention;

FIG. 6 illustrates selected portions of electronic ticket control system configured for public-venue auction in exemplary public facility according to one embodiment of the present invention; and

FIG. 7 is a flow chart illustrating a method of performing a public-venue auction according to an embodiment of the present invention.

### DETAILED DESCRIPTION OF THE INVENTION

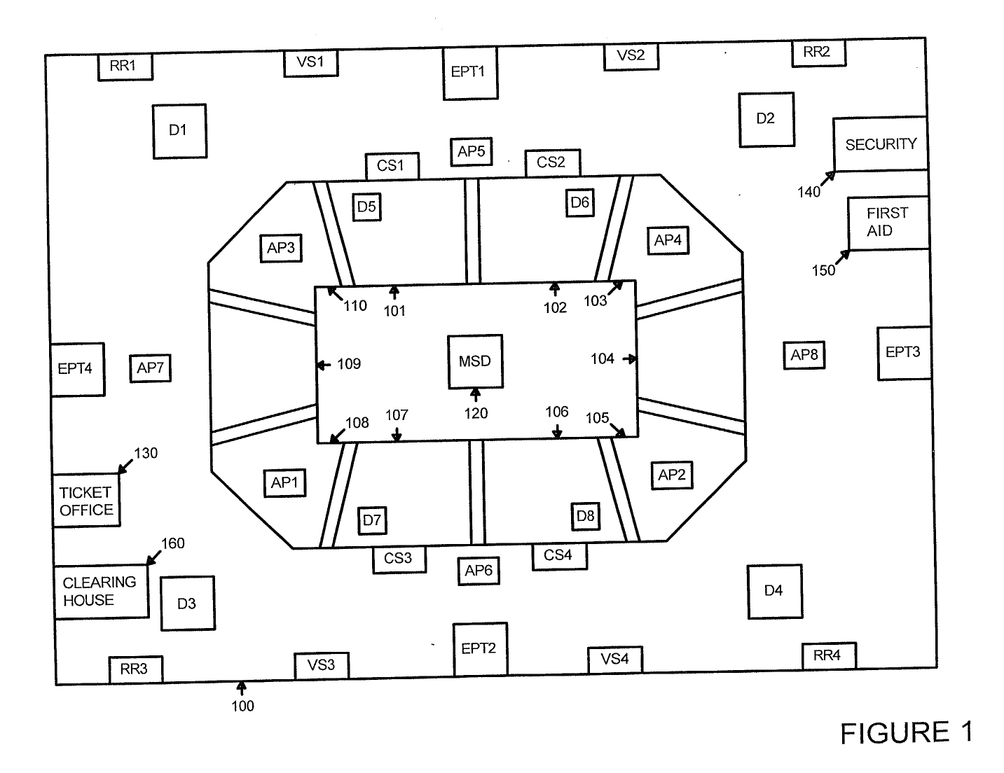

FIGS. 1 through 7, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged hand-held electronic organizer, personal digital assistant, or advanced mobile telephone.

FIG. 1 is a plan view of public facility 100 in which an electronic ticket control system according to the principles of the present invention may be deployed. Public facility 100 is representative of any public venue that is capable of holding a large audience. Thus, public facility 100 may include a football or baseball stadium, a basketball or hockey arena, a large concert hall, a convention center, and the like. As used herein and for the purpose of determining the scope of the claims of the present invention, the term “public facility” may include any controlled-access location to which people may be admitted by means of an electronic ticket control system and should not be construed to exclude facilities that are privately owned or that are open only to selected portions of the general public. In fact, public facility 100 may include controlled-access private clubs and private buildings, and even controlled-access forms of transportation, such as trains, planes, cruise ships, and the like. For the purpose of simplicity, however, in explaining the principles of the present invention, the public facility 100 shall be exemplified as a sports facility.

Public facility 100 comprises a plurality of seating areas, including exemplary seat sections 101-110, that surround a playing area (e.g., hockey rink, basketball court, indoor track, or the like). Suspended over the playing area is multi-sided display (MSD) 120, which has large display screens on four sides. The seating areas are surrounded by an exterior promenade area that contains a plurality of concession stands (CS), including four exemplary concession stands labeled CS1, CS2, CS3 and CS4. The promenade area also includes a number of rest rooms (RR), including exemplary rest rooms labeled RR1, RR2, RR3 and RR4, and numerous vendor shops (VS), including exemplary vendor shops labeled VS1, VS2, VS3 and VS4. Finally, the promenade area contains ticket office 130, security office 140, and first aid station 150, and auction clearinghouse (CH) 160.

Electronic displays of various types are positioned throughout public facility 100. In the promenade area, displays D1, D2, D3 and D4 enable patrons at the concession stands or vendor shops, or waiting in rest room lines, to view the sporting event that is ongoing in the playing area. In the seating area, patrons can view displays D5, D6, D7 and D8, which typically display advertisements, scores of other sporting events, player statistics, audience greetings, and the like. As used herein and for the purpose of determining the scope of the claims of the present invention, displays D1-D8 may be any type of conventional display devices, including electronic signs, conventional sized television sets, large screen television sets, and multisided television displays, that generally may be viewed by at least some of the customers of public facility 100 and do not include non-public displays which are only for the purpose of viewing by employees of public facility 100.

For example, each one of displays D1, D2, D3 and D4 may be an elevated multisided display system having three or four sides, wherein each side contains a large screen video display. Also, in an exemplary embodiment, one or more of displays D5-D8 in the seating area may be a conventional television set that is disposed in a luxury box of public facility 100.

Each of entry-point terminals EPT1, EPT2, EPT3 and EPT4 is disposed next to one of four entrances to public facility 100. EPT1, EPT2, EPT3 and EPT4 are capable of detecting and registering the virtual electronic tickets used by customers of public facility 100. EPT1-EPT4 read at least the encrypted authentication information from the virtual ticket device and authorize the customer to enter public facility 100. Each one of EPT1, EPT2, EPT3 and EPT4 registers the admission of each virtual electronic ticket by any one of several conventional technologies. For example, one or more of EPT1, EPT2, EPT3 and EPT4 may comprise an optical scanner that scans a bar code or a serial number displayed on the display of a virtual ticket device that stores each virtual electronic ticket. Alternatively, one or more of EPT1, EPT2, EPT3 and EPT4 may comprise a radio frequency transceiver that establishes an RF link (such as a Bluetooth connection), or an infrared (IR) transceiver that establishes an IR link, that transfers the virtual electronic ticket information from the virtual ticket device used by the customer to the entry-point terminal. In still another embodiment, one or more of EPT1, EPT2, EPT3 and EPT4 may contain a slot or a similar hardware interface into which a virtual ticket device may be inserted or engaged in order to transfer the virtual electronic ticket information via a wireline connection.

Additionally, a number of wireless or wireline access points (APs) are distributed throughout the seating area and the promenade area of public facility 100. Exemplary access points labeled AP1-AP8 are shown in FIG. 1. According to an advantageous embodiment of the present invention, EPT1-EPT4 may function both as access points and as entry-point terminals. AP1-AP8 provide communication channels that permit the virtual ticket devices used by customers to communicate with the electronic ticket control system associated with public facility 100. According to an advantageous embodiment of the present invention, AP1-AP8 are radio frequency transceivers similar to the base stations of a cellular telephone system that provide two-way radio frequency (RF) communication links with virtual ticket devices within public facility 100. Preferably, AP1-AP8 have a hand-off capability that allows a customer to roam throughout public facility 100 without losing communication with the electronic ticket control system. Advantageously, this allows the electronic ticket control system to continually track the location of each virtual ticket device in public facility 100.

However, in alternate embodiment of the present invention, one or more of AP1-AP8 may be physical interface slots into which virtual tickets devices may be inserted. For example, each seat in public facility 100 may be provided with an interface slot (similar to an electronic cradle) that may mate with a virtual ticket device. A wireline connection to each such interface slot enables each virtual ticket device to communicate with the electronic ticket control system. Furthermore, according to an advantageous embodiment of the present invention, exterior access points may be disposed in the areas outside of public facility 100 in order to communicate with customers as they are nearing, and before they enter public facility 100.

Access points, such as AP1-AP8 and EPT1-EPT4, may be used to provide a variety of user-friendly services to the patrons of public facility 100. When a customer is near, but not yet admitted to, public facility 100, the access points may transmit useful information to the virtual ticket device used by the customer, including directions to the nearest entrance, advice as to which entrance has the shortest waiting line, promotional items available at vendor shops, currently-available auction items, and the like. After the customer has been admitted to public facility 100, the access points may provide the virtual ticket device real time directions from her present location to her assigned seat, to particular concession stands or vendor shops, to rest rooms, or to other service areas. Information on which concession and service has the shortest line can also be provided.

Using the access points, the facility operator can know in real time how many admitted customers are at their seats and may schedule the start of programs on this basis. The customer can place orders for food and promotional items via the access points using the virtual ticket device and the vendors can deliver these goods to her present location. The access points and the virtual ticket device can also be used to authenticate the identity of the customer before the goods are turned over to her.

The facility operator may use the access points to convey a wide array of information, such as updates on facility or weather conditions, the availability of better seating, vendor promotions, exit instructions, and the like. Customers can use their virtual ticket devices to signal their present location within public facility 100 to friends and to locate lost family members. A network of entry-point terminals may be used within public facility 100 to authorize admission to various areas such as preferred seating sections, clubs, luxury boxes, reserved rest rooms, priority parking lots, and the like. Additionally, automated cameras in public facility 100 may be used to photograph the customers during an event and the photographs can later be identified with groups of virtual tickets and offered for sale to the customers. In the case of accidents or disruptions, the location information can be used to locate a medical station, direct emergency personnel, or contact potential witnesses. Additionally, seating and purchase information can be used for directed post-event marketing, which can be communicated directly to the virtual ticket device.

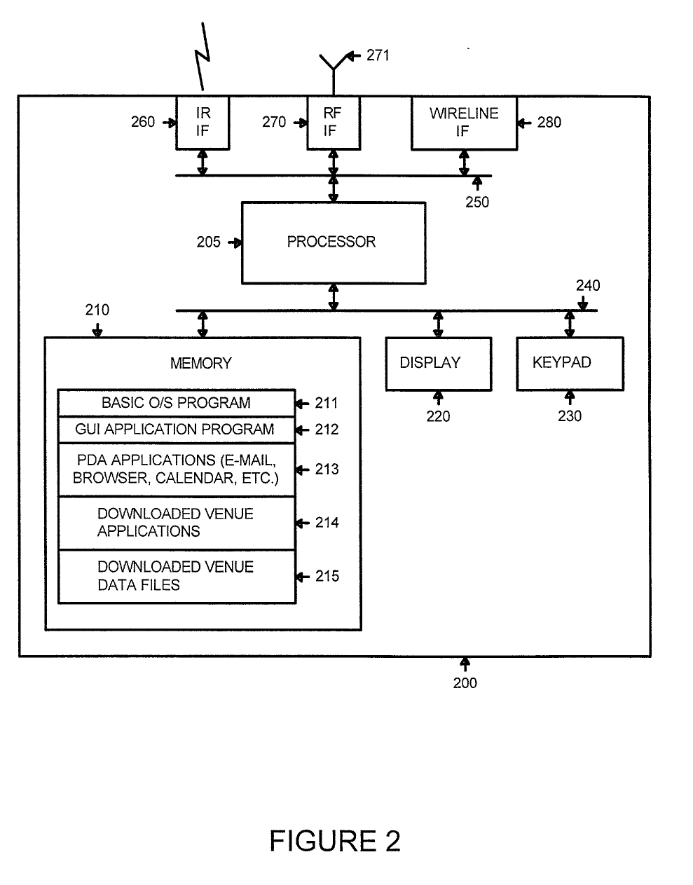

FIG. 2 illustrates virtual ticket device 200, which is capable of interacting with an electronic ticket control system according to the principles of the present invention. Virtual ticket device 200 comprises processor 205, memory 210, display 220, keypad 230, and one or more communication interfaces, including infrared (IR) interface (IF) 260, radio frequency (RF) interface (IF) 270, and wireline interface (IF) 280. Processor 205, memory 210, display 220, and keypad 230 are coupled to, and communicate via, system bus 240. Processor 205, memory 210, display 220, and keypad 230 are coupled to, and communicate via, input/output (I/O) bus 250.

Processor 205 controls the overall operation of virtual ticket device 200 by executing basic operating system (0/S) program 211 in memory 210. Memory 210 also stores graphical user interface (GUI) application program 212, a plurality of personal digital assistant (PDA) applications 213, downloaded venue applications 214, and downloaded venue data files 215. PDA applications 213 may include, for example, an e-mail application, a browser application, a calendar application, and the like.

In the illustrated embodiment, virtual ticket device 200 contains three external communication interfaces (Ifs), namely, infrared (IR) interface 260, radio frequency (RF) interface 270, and wireline interface 280. However, not all of these external communication interfaces are necessary to the operation of the invention. For example, in an advantageous embodiment of the present invention, virtual ticket device 200 may only contain wireline interface 280 and RF interface 270. Virtual ticket device 200 may be adapted for insertion into a cradle device that plugs into wireline interface 280 and provides virtual ticket device 200 with electrical power for recharging a battery (not shown) in virtual ticket device 200. When virtual ticket device 200 is plugged into a cradle device, applications and data may be downloaded or uploaded via wireline interface 280.

For example, in an advantageous embodiment of the present invention, virtual ticket device 200 may be a wireless enabled electronic organizer, such as a Palm VIITM organizer. As those skilled in the art are aware, a Palm VIITM organizer (or an equivalent appliance) is capable of communicating via a wireless interface (such as RF interface 270) and may be mounted in a cradle device that provides wireline communication and power supply voltages to the organizer.

Processor 205 executes GUI application program 212 in order to interact with the operator of virtual ticket device 200 via keypad 230 and display 220. Normally, GUI application program 212 enables processor 205 to execute PDA applications 213 stored in memory 210. One of these applications may include a browser application that allows virtual ticket device 200 to access via RF interface 270 or wireline interface 280 a website for a ticket agency in order to purchase a virtual electronic ticket to an event at public facility 100. When a virtual electronic ticket is purchased in this manner, the virtual electronic ticket and other useful applications and data files may be downloaded from the ticket agency website to virtual ticket device 200 and stored in downloaded venue applications 214 and downloaded venue data file 215.

Downloaded venue data file 215 may be used to store such information as the virtual electronic ticket, electronic maps of public facility 100, text information related to concession stands and vendor shops, and text information related to security and first aid at public facility 100. Downloaded venue applications 214 may include one or more applications executed by processor 205 when the customer is at public facility 100. In particular, downloaded venue applications 214 may include a communication application that enables processor 205 to control the operation of RF interface 270 and wireline interface 280 such that virtual ticket device 200 is capable of communicating with access points AP1-AP8 and entry-point terminals EPT1-EPT4 at public facility 100. For example, the communication application may configure RF interface 270 in virtual ticket device 200 to use the operating frequency channels and medium access control (MAC) layer protocols used by AP1-AP8 and EPT1-EPT4.

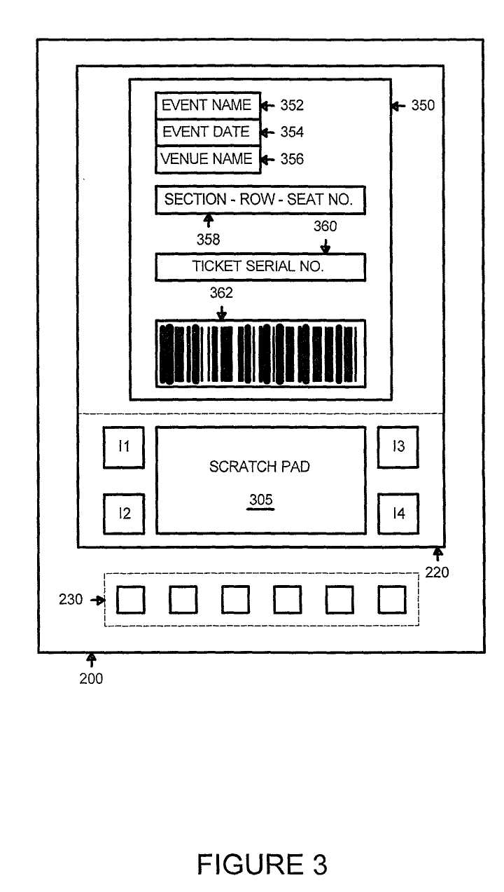

FIG. 3 illustrates virtual electronic ticket 350 displayed on virtual ticket device 200 according to one embodiment of the present invention. Virtual ticket device 200 comprises display 220, and keypad 230. The lower portion of display 220 contains scratch pad 305 and a plurality of icons, namely icons 11, 12, 13, and 14. The upper portion of display 220 contains virtual electronic ticket 350. Virtual electronic ticket 350 comprises event name field 352, event date field 354, venue name field 356, seating information field 358, ticket serial number field 360, and bar code field 362.

The operator of virtual ticket device 200 may use a stylus (not shown) or a similar device to select icons 11, 12, 13 or 14 and thereby launch one or more of PDA applications 213 in memory 210. Additionally, the operator may use the stylus to enter text or numbers in scratch pad area 305 when executing one of PDA applications 213 that permits the entry of text data. Additionally, the buttons in keypad 230 may be used to select icons or to perform functions such as scroll up, scroll down, scroll left, scroll right and the like.

When the customer approaches or enters public facility 100, the customer turns on virtual ticket device 200 and launches the communication application in downloaded venue applications 214 that allows virtual ticket device 200 to communicate with entry-point terminals EPT1-EPT4 and access points AP1-AP8 in public facility 100. The communication application may be launched automatically simply by selecting virtual electronic ticket 350 that has been downloaded and stored in downloaded venue data files 215. Event name field 352 contains the name of the event occurring in public facility 100, such as “New York Knicks vs. Indiana Pacers.” Event date field 354 contains the date on which the event is occurring, such as “Nov. 13, 2001.” Venue name field 356 contains the name of public facility 100, such as “Madison Square Garden.” Seating information field 358 contains the section, row and seat number information associated with virtual electronic ticket 350.

If the entry-point terminal contain an optical scanner, the optical scanner may scan one or both of ticket serial number field 360 and bar code field 362. An optical character recognition application may be used to read the serial number appearing in ticket serial number field 360. A conventional bar code scanner device may read the bar code in bar code field 362. In either event, when virtual electronic ticket 350 is identified, the entry-point terminal accesses the data base associated with the electronic ticket control system associated with public facility 100 and, if virtual electronic ticket 350 is properly authenticated, permits the customer to enter public facility 100. The entry-point terminal may produce a visible or audible signal approving entry by the customer. Alternatively, if virtual electronic ticket 350 is not authenticated, the entry-point terminal may generate an audible or visual alarm alerting a nearby gate attendant that the customer should not be admitted to public facility 100.

Display 220 may also be used to display text and graphical information associated with the public-venue auction system and method of the present invention, for example, an image of the item being auctioned or the amount of time remaining before bidding is closed.

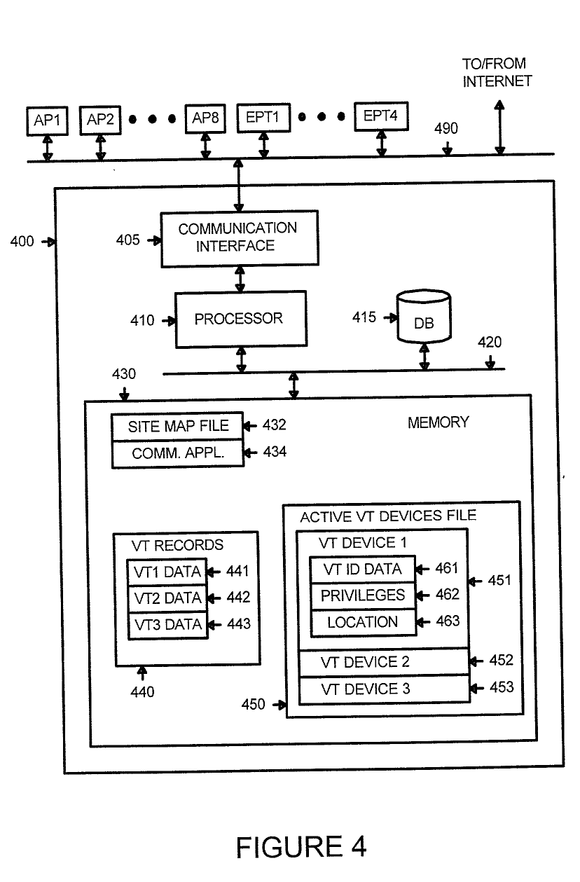

FIG. 4 illustrates electronic ticket control system 400 according to one embodiment of the present invention. Electronic ticket control system 400 comprises communication interface 405, processor 410, database (DB) 415, and memory 430. Processor 410, database (DB) 415, and memory 430 are coupled to, and communicate via system bus 420. Communication interface 405 has an external network connection that interfaces with network bus 490. Communication interface 405 enables processor 410 to communicate with exemplary access points AP1-AP8 and exemplary entry-point terminals EPT1-EPT4. Communication interface 405 also enables processor 410 to communicate with remote servers and other devices via the Internet.

Memory 430 stores site map file 432, communication application program 434, virtual ticket records 440, and active virtual ticket devices file 450. Virtual ticket records 440 contains a plurality of virtual ticket data records 441-443, which are arbitrarily labeled VT1 DATA, VT2 DATA and VT3 DATA, respectively. Virtual ticket records 440 comprises a master list of all virtual tickets that were sold to the particular event occurring at public facility 100. Each virtual ticket data record 441-443 contains the serial number or bar code of each virtual ticket, the section and seat number information associated with each virtual ticket, payment information (optionally), the privileges associated with each virtual ticket, and the like. The virtual tickets that are received from the virtual ticket devices are compared to the virtual ticket data in virtual ticket records 440 before admitting each customer to public facility 100.

Virtual ticket data records 441-443 may be downloaded via the Internet from a server associated with a ticketing agency that sells tickets to events held at public facility 100. Alternatively, electronic ticket control system 400 itself also may function as a server that potential customers may access over the Internet in order to buy virtual tickets. As each virtual ticket is sold to a potential customer, electronic ticket control system 400 creates and stores a corresponding virtual ticket data record 441 and transmits the electronic virtual ticket over the Internet to the customer.

Active virtual ticket devices file 450 contains virtual ticket device records 451-453 associated with virtual ticket devices that are in active communication with electronic ticket control system 400. After each received virtual ticket is received and authenticated, a virtual ticket device record for the corresponding virtual ticket device that has been admitted is created in active virtual ticket device file 450. Virtual ticket device records 451-453 are arbitrarily labeled VT DEVICE 1, VT DEVICE 2, and VT DEVICE 3, respectively. Exemplary virtual ticket device record 451 comprises virtual ticket (VT) identification (ID) data field 461, privileges field 462, and location field 463. Database 415 normally holds the master copies of all of the information stored in memory 430. However, the information in database 415 is loaded into memory 430 for processing by processor 410.

Site map file 432 contains electronic map data that may be downloads to virtual ticket device 200 in order to display the location of the seat corresponding to a particular virtual ticket. The electronic map data also may illustrate the locations of the rest rooms, concession stands, vendor shops, ticket office 130, security office 140 and first aid station 150. Virtual ticket identification field 461 identifies the virtual ticket associated with virtual ticket device record 451. Privileges field 462 indicates the restricted areas in public facility 100 to which the virtual ticket gains admission. For example, privileges field 462 may indicate which restaurants and luxury boxes the user of a particular virtual ticket may enter. Finally, location field 463 indicates the current location of virtual ticket device 200.

Communication application program 434 comprises a communication protocol that may be transmitted to virtual ticket device 200 in order to permit virtual ticket device 200 to communicate with the access points and entry-point terminals in public facility 100. According to one embodiment of the present invention, a user of virtual ticket device 200 may download communication application program 434 from electronic ticket control system 400 via the Internet before going to public facility 100. Alternatively, electronic ticket control system 400 may initially use a standard protocol to establish a simple connection with virtual ticket device 200 and then may download communication application 434 is order to establish a more advanced communication link.

For example, if EPT1 and virtual ticket device 200 are both Bluetooth-enabled systems, EPT1 may establish an initial Bluetooth connection with virtual ticket device 200 as the user of virtual ticket device 200 approaches EPT1. After the Bluetooth connection is established, EPT1 may download communication application program 434 to virtual ticket device 200. Thereafter, virtual ticket device 200 may use communication application program 434 to establish wireless LAN (e.g., IEEE 802.11) connections with one or more of EPT1-EPT4 and AP1-AP8 as the user of virtual ticket device 200 roams around public facility 100.

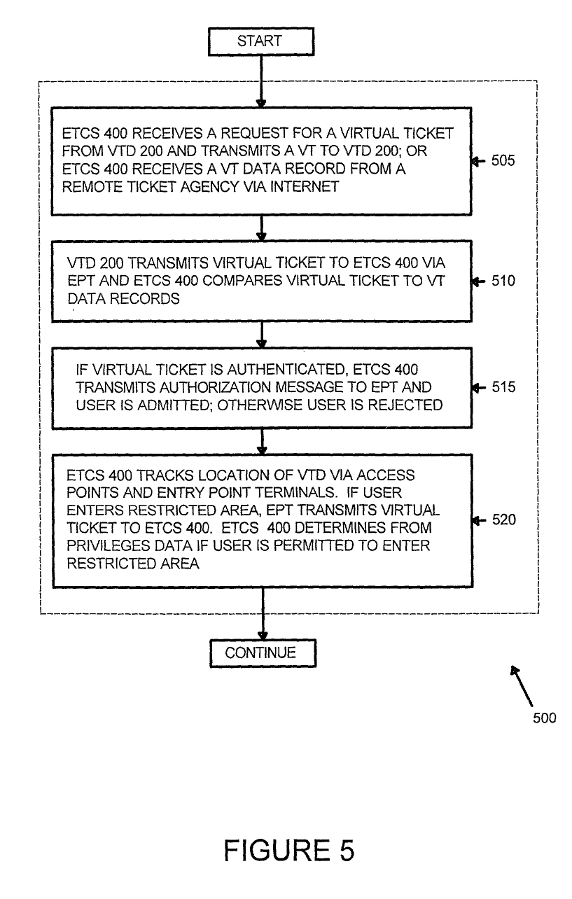

FIG. 5 depicts flow diagram 500, which illustrates the operation of electronic ticket control system 400 and portable virtual ticket device 200 according to one embodiment of the present invention. Initially, electronic ticket control system 400 receives a request for a virtual ticket from virtual ticket device 200. This request may be received via the Internet or via a telephone connection. In response, electronic ticket control system 400 transmits a virtual ticket to virtual ticket device 200. Alternatively, electronic ticket control system 400 may receive a virtual ticket data record for an already issued ticket from a remote ticket agency via the Internet (process step 505).

When the user finally arrives at public facility 100 to attend the event, virtual ticket device 200 transmits the virtual ticket stored in the virtual ticket device 200 to electronic ticket control system 400 via an entry-point terminal. Electronic ticket control system 400 then compares the virtual ticket to the virtual ticket data records 440 stored in memory 430 or database 415 (process step 510). If the virtual ticket is authenticated, electronic ticket control system 400 transmits an authorization message to the entry-point terminal and the user is admitted. Otherwise, the user is rejected (process step 515).

During the event, electronic ticket control system 400 may track the location of virtual ticket device 200 via the numerous access points and entry-point terminals. If the user attempts to enter a restricted area, such as a private restaurant, a luxury box, or a premium seating area, the entry-point terminal at the restricted area transmits the virtual ticket to electronic ticket control system 400. Electronic ticket control system 400 determines from the privileges data whether or not the user is permitted to enter the restricted area (process step 520).

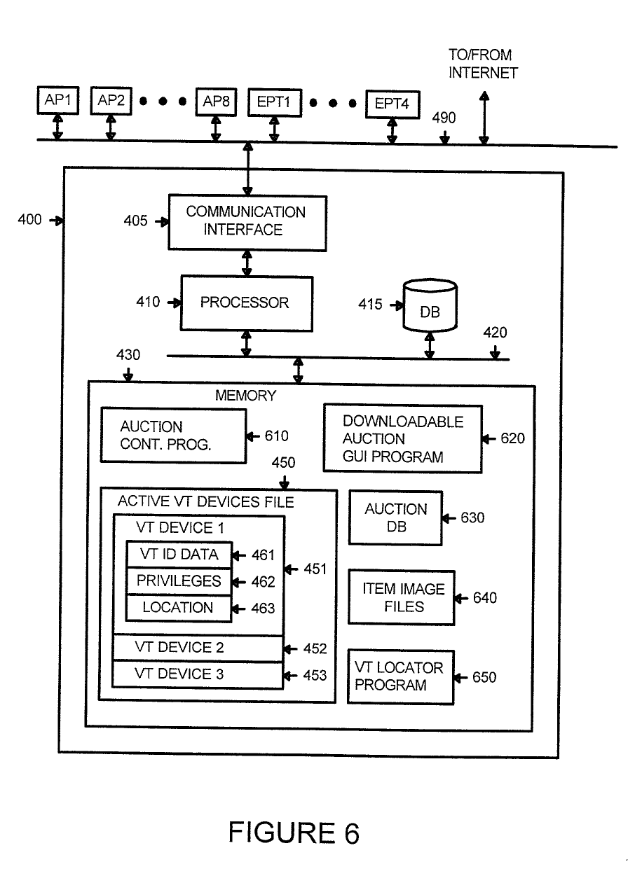

FIG. 6 illustrates selected portions of electronic ticket control system 400 configured for public-venue auction in exemplary public facility 100 according to one embodiment of the present invention. In addition to the components illustrated in FIG. 4 and described above, electronic ticket control system 400 also comprises a plurality of application programs and data files stored in memory 430 that enable electronic ticket control system 400 to communicate with virtual ticket devices in order to transmit and receive auction-related communications. Memory 430 stores auction control program 610, downloadable auction graphical user interface (GUI) program 620, auction database (DB) 630, item image files 640, and VTD locator program 650.

Processor 410 executes program instructions in auction control program 610 to enable electronic ticket control system 400 to communicate with virtual ticket devices in order to conduct the public auction. It was noted in the above description of FIG. 2 that downloaded venue applications 214 in virtual ticket device 200 may include one or more applications executed by virtual ticket device 200 when the customer is at public facility 100. These applications may be downloaded before the customer arrives at public facility 100 (e.g., via the Internet) or may be downloaded at public facility 100 via entry point terminals EPT1-EPT4 or access points AP1-AP8. Downloadable auction GUI program 620 is one such downloadable program. Auction GUI program 620 provides a graphical user interface in virtual ticket device 200 that enables the user to interact with auction control program 610.

According to an exemplary embodiment of the present invention, the graphical user interface of auction GUI program 620 may be similar to an e-mail application or to a two-way paging application. Auction GUI program 620 displays a listing of one or more currently available auction items to the user of virtual ticket device 200 and invites the user to participate in the auction. Alternately, an auction-event notice may be sent as each auction item becomes available, or according to a staggered-start schedule (so that bidding does not open or close on all items at the same time). Auction items may include items related to an event at the public facility such as souvenirs actually obtained at the game, such as a home run caught by a fan. They may also include items which related to an event at the public facility offered by the facility operators, vendors, or local charity. A picture autographed by an entire team may be sold to the patron offering the largest donation. A great advantage may be obtained by using the auction system of the present invention where a record has been set, some milestone reached, or some other feat; a memento can be auctioned upon the same day to the very fans who were present and witnessed the event. The facility owner retains a portion of the eventual sale price as a service fee, obtaining a benefit whether the fee is retained as revenue or donated to charity as a public service.

To participate, the user enters either a bid on a listed item or information related to an item the user wishes to sell. Or the user may elect not to participate by indicating that other auction messages should be sent only if new auction items are added to the list, or by indicating a total lack of interest in any auction messages.

Auction database (DB) 630 is a master list of all auction items in the list for public facility 100. Processor 410, under control of auction control program 610, determines from auction database 630 which items have been sold and which remain available. Auction control program 610 may then generate and transmit to virtual ticket device 200 a message relaying a list of one or more of the available auction items. Advantageously, the message may include at least one picture file showing an auction item or items, if item images are available. Pictures of items being auctioned (or, equivalently, of an image representing the auction item) are stored in item-image files 640. The message also may include other information related to an auction event such as reserve or minimum bid price, the quantity of similar items being auctioned, or the amount of time remaining in the auction event.

Since many patrons are part of a group, in an advantageous embodiment of the present invention, auction control program 610 may time the sending of messages relating to particular auction events so that each person in a targeted facility area receives the message simultaneously. Target areas may be used advantageously, for example, when a number of identical or similar items are being auctioned, with various selected sections or groups of patrons being given the opportunity to bid on one of them. Timed messages may also be used to ensure important updates are sent, for example, only during time-outs or intermissions. Or messages may be sent at more rapid intervals when nearing the end of a particular auction event.

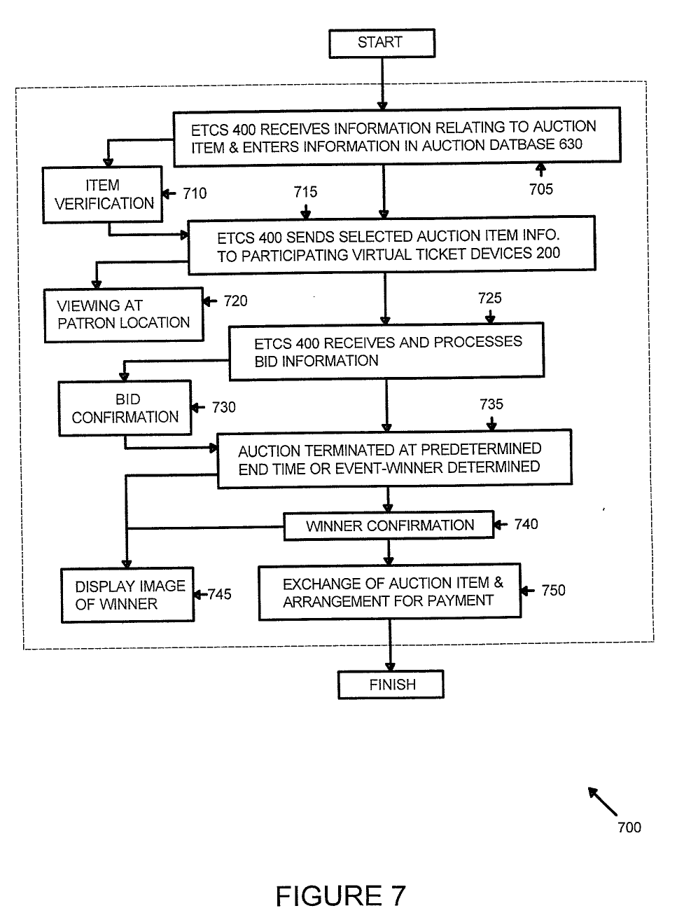

FIG. 7 is a flow chart illustrating a method 700 of performing a public-venue auction according to an embodiment of the present invention. Initially, (process START) the auction database clears the auction data stored in relationship to previous auction events. An auction event, as that term is used herein, encompasses all inputs, outputs, and related transactions related to the sale of an auction item, or a group of items sold as a unit. Note that numerous auction events may proceed at the same time, each with its own beginning and end times. Typically, one event has no impact on any other (except to the extent they may be using the same processor 410, a circumstance that normally has no patron-noticeable effect).

In an alternate embodiment, however, auction events are supervised and their progress may influence how the other events proceed. For example, if bidding for a particular item has reached relatively high levels, other auction events may be interrupted or given a lower priority. Or, if autographed baseballs are commanding greater interest than expected, more similar items may be offered at the expense of an auction for an event program that is generating little interest. Note that FIG. 7, for clarity, will illustrate only a single auction event, but without an implication that there may not be many more. Although the auction database is initially cleared, the data related to previous auctions may have archived for future reference. In one embodiment, for example, selected data related to auctions past may be made available for use by patrons in reviewing the bidding history of a particular item or of an item similar to one currently being auctioned.

Continuing to refer to FIG. 7, electronic ticket control system 400 receives information relating to an auction item and stores it in auction database 630 (process step 705). The information may include a description of the item, and give a public-facility or image-file location where it can be viewed (for example, at clearinghouse 160). The information also includes auction-related conditions such as how long bidding will remain open, any minimum or reserve, and, if applicable, that the proceeds will be donated to a charity. At this juncture, the process may (optionally) proceed to item verification (process step 710). While verification is certainly not necessary in all cases, it may be desirable where, for instance, an auction item has been registered by a patron through a virtual ticket device 200. Items offered by the facility operator, on the other hand, would require no verification procedure. Likewise, patron items may have been previously bailed at clearinghouse 160 so that verification, in effect, has already been performed.

Example 1—A patron catches a homerun baseball at the World Series. Immediately the patron offers the baseball up for auction thereby auctioning the ball at the height of interest. Perhaps if he makes the baseball available only for a short period of time he may create extreme interest and get the highest price. He informs, the public facility via his virtual ticket device, that the baseball should only be up for auction for the next twenty minutes. The auction facility indicates on the virtual ticket device 200 the auction fee the facility will charge in order for the patron to proceed with the auction.

Example 2—Each patron receives a free Beanie Baby® upon entering the baseball game. The patron decides that he would gladly sell the Beanie Baby® to anyone who would like an additional Beanie Baby®. The patron offers the Beanie Baby® up for auction throughout the entire game, and sells to the highest bidder. The public facility indicates on the patron's virtual ticket device the auction fee it will charge to facilitate the auction.

Once the auction item information has been entered and, if necessary, verified, an auction item notice is sent to participating virtual ticket devices (process step 715). The set of participating devices may be defined in a number of ways according to the preference of the facility operator and their patrons. The notice may simply be sent to all active virtual ticket devices automatically or, alternately, to those who have registered an interest in auction participation. Patrons receiving an auction item notice on their virtual ticket devices may then indicate whether they wish to continue participating or to participate conditionally (for example, only with regard to certain items, only for charitable actions, or only in the last ten minutes of bidding) Participating patrons will be sent auction-event status updates according to a predetermined pattern, although perhaps one which they may alter through the use of downloadable auction GUI program 620 (step not shown). optionally, and presumably only in certain circumstances, a patron may request to view the auction item at their seat, or the facility operator's auction manager may suggest such a viewing (process step 720). (The patron's location may be determined by VTD locator program 650 analyzing inputs from various access points, or may be entered by the patron themselves.)

The electronic ticket control device then receives bids, and stores the bid information in auction database 630 (process step 725). Processor 410, under the control of auction control program 610, analyzed the bids to associate them with a particular auction item and to rank them so that the highest bid for an item is always known. In this embodiment, all bids are stored in case higher bids are withdrawn or invalidated. Preferably, the bid information includes the identity of the virtual ticket device 200 through which it was entered. Again, patrons are updated on the progress of the bidding. Optionally, a bid confirmation may be performed (process step 430). This step may amount to no more than requesting the patron confirm, through the virtual ticket device 200, that the bid was correctly entered. It may also include confirming the patron's identity by requesting entry of a personal identification number (PIN). In this way, the public-facility operator can, for example, screen out bids submitted through stolen virtual ticket devices.

The bid verification step may also include, where applicable, a credit-history check. The database 415 may also store historical bidding data relating to patrons who have reneged on auction-item purchases in the past, perhaps rejecting their bids to discourage prank bidding. The process of receiving bids continues until the auction terminates and a winner is determined (process step 735). The auction may terminate according to a pre-set schedule or because no higher-value bid has been received for a certain period of time. Auction termination may also be tied to the end of whatever event is taking place at public facility 100.

At this point, a confirmation (process step 740) is performed. Here, the buyer is queried through virtual ticket device 200 regarding terms of payment and perhaps given the opportunity to decline. (If an auction winner does decline, the confirmation step may be performed with respect to the second-highest bidder, (step not shown) and so on.) If desired, a picture (taken by a facility camera) of the highest bidder may be displayed on MSD 120 or on any one or all of displays D1-D8 (process step 745). This display may occur after either of steps 735 or 740. Finally, the actual exchange of the auction item and the winner's payment is made, usually at clearinghouse 160 or at the patron's location (process step 750). If the auction item was provided by a patron, the public facility can then collect an auction fee from the seller or buyer either based on the highest bid which was received or a flat fee or some other fee scheme.

Although the present invention has been described in detail, those skilled in the art should understand that they can make various changes, substitutions and alterations herein without departing from the spirit and scope of the invention in its broadest form.

What is claimed is:

1. A method of doing business, comprising:
receiving auction-item information in a public-facility electronic ticket control system wherein the auction item relates to an event at the public facility;
transmitting selected portions of the auction-item information to virtual ticket devices in communication with the electronic ticket control system through public-facility access points;
receiving in the electronic ticket control system at least one communication from a virtual ticket device, wherein the communication contains bid information relating to the auction item; and
determining, at a pre-selected termination point, which of the at least one communications contains the bid of highest value, thereby determining the winner of the auction.

2. The method of doing business of claim 1, further comprising the step of providing a downloadable user-interface program for patrons of the public facility to download to a virtual ticket device.

3. The method of doing business of claim 1, wherein the selected portions of auction-item information transmitted to virtual ticket devices is transmitted in a plurality of successive transmissions, wherein each subsequent transmission contains at least some auction-item information not previously transmitted.

4. The method of doing business of claim 3, wherein at least one of the plurality of successive transmissions was sent in response to a request received from a virtual ticket device.

5. The method of doing business of claim 3, wherein at least one of the plurality of successive transmissions contains image information for displaying on a virtual ticket device display an image representative of the auction item.

6. The method of doing business of claim 1, further comprising the step of verifying the accuracy of at least a portion of the received auction item information

7. The method of doing business of claim 1, further comprising the step of confirming a communication containing bid information.

8. The method of doing business of claim 7, wherein the confirming step includes transmitting a confirmation request to the virtual ticket device from which the communication was received.

9. The method of doing business of claim 8, wherein the confirmation request is sent automatically by the electronic ticket control system upon determining that the received bid information meets pre-determined criteria.

10. The method of doing business of claim 7, wherein the confirming step includes checking the creditworthiness of the patron associated with the virtual ticket device from which the bid-information communication was received.

11. The method of doing business of claim 1, further including the step of delivering the auction item to the winner of the auction and charging an auction fee.

12. The method of doing business of claim 1, further comprising the steps of:
determining the location of a virtual ticket device from which bid information has been received; and
delivering the auction item to a location near the determined location of the virtual ticket device for inspection by patrons in the vicinity.

13. The method of doing business of claim 1, wherein the auction item is one of a plurality of auction-items being auctioned during the same public-facility event.

14. The method of doing business of claim 13, further comprising the step of prioritizing the auction items.

15. In a public facility having an electronic ticket control system capable of communicating through public-facility access points with virtual ticket devices in proximity to the public facility; a public-venue auction system, comprising:
an auction database for storing auction item information received by the electronic ticket control system, wherein the auction items are related to an event at the public facility;
an auction-control program for directing the processor to select auction-item information for transmission to virtual ticket devices, for processing bid information received from virtual ticket devices, and for determining at the termination of the auction which virtual ticket device submitted the highest bid.

16. The public-venue auction system of claim 15, further comprising an item-image file accessible to the processor for storing images representative of auction items.

17. The public-venue auction system of claim 15, further comprising a virtual ticket device locator program for directing the processor to analyze received bid information to determine the location of the virtual ticket device from which it was transmitted.

18. The public-venue auction system of claim 15, further comprising a downloadable user-interface program for downloading by public-facility patrons to virtual ticket devices.

19. The public-venue auction system of claim 15, further comprising a communications-network interface such that the user-interface program can be downloaded to virtual ticket devices not in proximity to the public facility through the communications network.

20. The public-venue auction system of claim 19, wherein the communications network is the Internet.

21. In a public facility having an electronic ticket control system for communicating through public-facility access points with virtual ticket devices, a method of performing an auction comprising the steps of:
providing an auction control program in the electronic ticket control system;
providing an auction-item database accessible to the auction control program for storing information relating to items to be auctioned, wherein the items are related to an event at the public-facility;
receiving auction-item information and storing it in the auction-item database;
transmitting selected auction-item information to at least one virtual ticket device;
receiving at least one bid from a virtual ticket device;
storing the bid in the auction-item database; and
determining that a received bid is the highest received bid.

22. The method of claim 21, wherein the auction-item information is received from a virtual ticket device and relates to an auction item that a patron wishes to sell.

23. The method of claim 21, wherein the auction-item information is received from a virtual ticket device and relates to an auction item that a patron wishes to purchase.

24. The method of claim 21, wherein the step of determining is performed at a predetermined auction-termination time.

25. The method of doing business of claim 21, wherein the auction-item information includes a sale price limitation.

26. A method of doing business, comprising:
receiving auction-item information in a public-facility electronic ticket control system wherein the auction item relates to an event at the public facility;
transmitting selected portions of the auction-item information to virtual ticket devices in communication with the electronic ticket control system through public-facility access points;
receiving in the electronic ticket control system at least one communication from a virtual ticket device, wherein the communication contains bid information relating to the auction item; and
charging an auction fee for facilitating the auction.

27. The method of doing business as claim in claim 26, wherein the auction fee is based on a percentage of the highest bid.

28. The method of doing business as claimed in claim 26, wherein the auction fee is only charged upon successful completion of the auction.

29. The method of doing business as claimed in claim 26, wherein the auction fee is a flat rate fee.
